(19) United States
(12) Patent Application Publication
(10) Pub. No.: US 2007/0127766 A1
(43) Pub. Date: Jun. 7, 2007

(54) Multi-channel speaker utilizing dual-voice coils

(76) Inventor: Christopher Combest, Leawood, KS (US)

Correspondence Address: HOVEY WILLIAMS LLP, 2405 GRAND BLVD., SUITE 400, KANSAS CITY, MO, 64108, US

(21) Appl. No.: 11/291,794

(22) Filed: Dec. 1, 2005

(51) Int. Cl. H04R 25/00

(52) U.S. Cl. 381/401; 381/182; 381/396

(57) ABSTRACT

A speaker that utilizes a dual voice coil speaker element to generate sound corresponding to more than one sound channel is disclosed. The speaker may be paired with a substantially identical speaker to generate stereo sound corresponding to left and right channel signals and monaural sound corresponding to a center channel signal. Such a configuration enables the speakers to generate sound corresponding to side and center channel signals without requiring the use of discrete speaker elements for each channel.

### BACKGROUND OF THE INVENTION

1. Field of the Invention

The present invention relates to speakers. More particularly, the invention relates to speakers that utilize dual-voice coils to generate stereo sound corresponding to side channels and monaural sound corresponding to a center channel.

2. Description of the Related Art

Home theater systems are becoming increasingly popular due to the ready availability of high quality video and audio components. These systems generally include a television and a surround sound audio system having a plurality of speakers to immerse viewers in sound. Typically, surround sound systems compatible with the often-used 5.1 standard employ six speakers: a sub-woofer and five satellite speakers corresponding to five discrete audio channels: center; stereo left and right; and stereo left rear and right rear.

Unfortunately, to utilize the plurality of sound channels, viewers must find a placement location for each of the discrete speakers. Due to physical space constraints and the number of speakers utilized, this task is often difficult or impossible. Further, the increasing popularity of low-profile televisions, such as plasma, LCD, and flat-panel designs, has further complicated surround sound speaker placement due to their space efficient design. For example, low-profile televisions lack an area for coupling with a center channel speaker thereby inhibiting full use of surround sound capabilities.

To overcome such difficulties, it is known to utilize side channel speaker enclosures, such as a left or right channel speaker enclosure, to house both side channel and center channel speaker elements. In such configurations, separate and discrete speakers elements are utilized for the side and center channels to enable the left and right channel signals to be broadcast in stereo and the center channel signal to be broadcast in monaural to simulate the effect of a speaker placed centrally between the left and right speaker enclosures. Such a system is disclosed in U.S. Pat. No. 6,918,461, entitled “Dual Mono Center Channel,” filed Feb. 20, 2003, which is incorporated herein by reference.

Although such systems eliminate the need for a centrally-placed center channel speaker, they increase the number of speakers required to be housed within the left and right speaker enclosures, resulting in increased system cost, size, and complexity. For example, such large speaker enclosures generally house at least two speakers per channel, resulting in a total of four speakers, two tweeters and two woofers per enclosure. These enclosures are often too large for placement or are aesthetically or structurally incompatible with low-profile televisions or in-wall enclosures. Thus, viewers often elect to forgo utilization of the beneficial center channel due to the bulky or numerous enclosures required by conventional systems.

### SUMMARY OF THE INVENTION

The present invention solves the above-described problems and provides a distinct advance in the art of speakers. More particularly, the invention provides a pair of speakers that utilize dual-voice coils to generate stereo sound corresponding to side channels and monaural sound corresponding to a center channel. Such a configuration enables each speaker to generate sound corresponding to side and center channel signals without requiring the use of additional speaker elements.

In one embodiment, the present invention provides a speaker system operable to be coupled with a multi-channel sound system. The system broadly includes a first speaker and a second speaker. The first speaker includes inputs operable to receive a left channel signal and a center channel signal from the sound system and the second speaker includes inputs operable to receive a right channel signal and the center channel signal from the sound system. Each speaker further includes a dual voice coil speaker element operable to generate sound corresponding to two channels. The first speaker is operable to generate sound corresponding to the left channel signal and the center channel signal and the second speaker is operable to generate sound corresponding to the right channel signal and the center channel signal.

In another embodiment, the speaker system includes a first speaker and a second speaker. The first speaker includes inputs operable to receive a left and a center channel signal, a first dual voice coil speaker element comprising a tweeter, a second dual voice coil speaker element comprising a woofer, and a first speaker enclosure for housing at least a portion of the dual voice coil speaker elements. The second speaker includes inputs operable to receive a right and the center channel signal, a third dual voice coil speaker element comprising a tweeter, a fourth dual voice coil speaker element comprising a woofer, and a second speaker enclosure for housing at least a portion of the dual voice coil speaker elements. Each dual voice coil speaker is operable to generate sound corresponding to two channels such that the speakers are operable to be positioned to generate stereo sound corresponding to the left and right channel signals and monaural sound corresponding to the center channel signal.

In another embodiment, the present invention provides a method of providing sound corresponding to a plurality of channel signals. The method generally includes coupling a first dual voice coil speaker element with a left channel signal and a center channel signal, coupling a second dual voice coil speaker element with a right channel signal and the center channel signal, and positioning the first dual voice coil speaker element and the second dual voice coil speaker element to provide stereo sound corresponding to the left and right channel signals and monaural sound corresponding to the center channel signal.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a perspective view of speakers configured in accordance with various preferred embodiments of the present invention, the speakers shown positioned in proximity to a television;

FIG. 2 is a schematic view of one of the speakers of FIG. 1; and

FIG. 3 is an exploded view showing a dual voice coil speaker element utilized by the speaker of FIG. 2.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

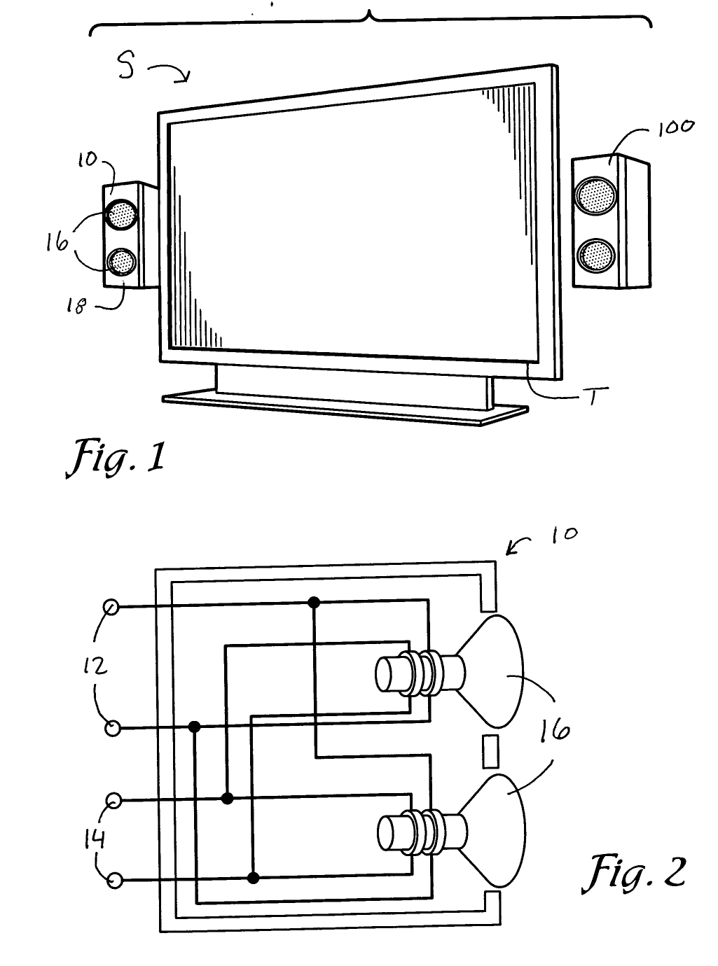

Referring to FIGS. 1-3, a speaker 10 is shown constructed in accordance with various preferred embodiments of the present invention. As is described below in more detail, the speaker 10 may comprise a portion of a multi-channel sound system S to generate sound corresponding to one or more channel signals. “Sound” as utilized herein generally corresponds to transmitted vibrations of any frequency, but preferably corresponds to human-detectable vibrations having a frequency approximately between 10 Hz and 25,000 Hz.

The speaker 10 broadly includes a first input 12 operable to receive a channel signal from the sound system S, a second input 14 operable to receive another channel signal from the sound system S, a dual voice coil speaker element 16 coupled with the inputs 12, 14 to generate sound corresponding to the channel signals, and a speaker enclosure 18 for housing at least a portion of the dual voice coil speaker element 16.

The inputs 12, 14 are each coupled with the sound system S to enable reception of channel signals. The inputs 12, 14 may include conventional sockets, plugs, jacks, connecting elements, combinations thereof, etc, that are operable to couple with the sound system S utilizing speaker wire or other cabling. However, the inputs 12, 14 may comprise any elements operable to receive an electrical or optical signal, including wireless elements, and need not be limited to the above-articulated elements. Additionally, in various embodiments the speaker 10 may additionally include further inputs, in addition to the first input 12 and the second input 14, to enable the reception of additional channel signals.

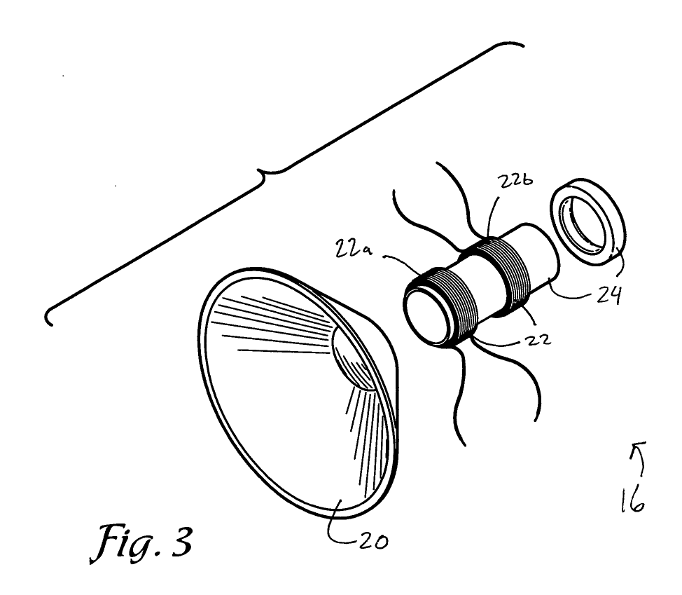

As shown in FIG. 3, the dual voice coil speaker element 16 generally comprises a cone 20, dual coils 22 coupled with the cone 20, and a magnet 24 having one pole oriented coaxially with the dual coils 22. As is known in the art, upon application of an electrical signal to at least one of the coils 22, the coils 22 and the magnet 24 generate magnetic force which forces the coils 22 to oscillate at the frequency of the applied electrical signal. The coupling of the coils 22 to the cone 20 further causes the cone 20 to oscillate and generate sound at the frequency of the applied electrical signal.

The coils 22 are coupled with the inputs 12, 14 to enable channel signals received by the inputs to be applied to the coils 22. For instance, a first coil 22a may be coupled with the first input 12 and a second coil 22b may be coupled with the second input 14 to enable the dual voice coil speaker element 16 to generate sound corresponding to both received channel signals without requiring the utilization of additional speaker elements.

It should be appreciated by those skilled in the art that innumerable dual voice coil configurations may be utilized by the present invention to provide the dual voice coil speaker element 16. For instance, the dual voice coil speaker element 16 may comprise any speaker element having more than one coil for generating sound corresponding to signals provided by the coils.

As shown in FIG. 2, in various embodiments the speaker 10 may include a plurality of dual voice coil speaker elements 16 that are each operable to generate sound corresponding to multiple channels. In such embodiments, one dual voice coil speaker element 16 may comprise a tweeter, another dual voice coil speaker element 16 may comprise a woofer, another dual voice coil speaker element may comprise a mid-range speaker element, etc, to provide a full range of sound corresponding to multi-channels and multiple frequency ranges within each channel.

To facilitate usage of tweeters, woofers, and other speaker element configurations, it may be desirable to couple the dual voice coil speaker elements 16 with a filter, such as a cross-over filter, to apply appropriate frequency ranges to each speaker element. However, utilization of more than one dual voice coil speaker element is not necessary in all embodiments.

The speaker enclosure 18 may house at least a portion of the inputs 12, 14 and dual voice coil speaker elements 16 to facilitate generation of sound by preventing out-of-phase sound from the rear of the dual voice coil speaker elements 16 from interfering with the generated positive phase sound from the front of the dual voice coil speaker elements 16. Thus, the speaker enclosure 18 may comprise various housings, such as box-type housings, wall-mounted enclosures, or an integral audiovisual housing including both the dual voice coil speaker element 16 and a television, computer monitor, or other display.

In operation, the speaker 10 is coupled with the sound system S such that a first channel signal is provided to the first input 12 and a second channel signal is provided to the second input 14 to enable the dual voice coil speaker element 16 to generate sound corresponding to both channels. Preferably, the first channel signal corresponds to a side channel, such as a left or right channel, and the second channel signal corresponds to a center channel, to enable the speaker 10 to generate sound corresponding to both channels.

As is known in the art, multi-channel sound systems S, such as those that may be utilized in combination with the present invention, are operable to provide a plurality of channel signals to generate surround sound. Multi-channel sound systems generally provide a plurality of channel signals that each correspond to particular channels, such as left, right, center, rear left, rear right, center-right, center-left, etc.

Preferably, the speaker 10 is coupled with a 5.1, 6.1, 7.1, etc, compatible sound system to enable the speaker 10 to generate sound corresponding to center and side channels, as is discussed above. However, the speaker 10 may be coupled with any sound systems operable to generate more than one channel signal and/or with any combination of channels.

In various embodiments, the speaker 10 may be paired with a substantially identical second speaker 100 to form a speaker system. The second speaker 100 is configured in a similar manner to the speaker 10, with the exception that its inputs are coupled with the center channel signal and a third channel signal, different that the first channel signal, to enable the generation of stereo sound. For instance, the speaker 10 may receive the center channel signal and the left channel signal and the second speaker 100 may receive the center channel signal and the right channel signal. Such a configuration enables the generation of stereo sound corresponding to the left and right channel signals and the generation of monaural sound corresponding to the center channel signal.

For example, the speaker 10 may be placed on a left side of an audiovisual (AV) element, such as a television T, and the speaker 100 may be placed on a right side of the television T, to enable a viewer positioned in front of the television T to hear both stereo sound from the left and right channels and monaural sound from the center channel. Thus, utilization of the speaker 10 and speaker 100 effectively emulates the utilization of conventional and discrete left, center, and right speakers through utilization of dual voice coil speaker elements without requiring placement of three discrete speakers.

Further, utilization of the dual voice coil speaker element 16 minimizes the number of speaker elements required by the speaker 10 and speaker 100 to generate sound corresponding to both channels. For example, the speaker 10 and speaker 100 may each include a single dual voice coil speaker element to each generate sound corresponding to two channels. Similarly, the speaker 10 and speaker 100 may each include dual voice coil speaker elements corresponding to woofers and tweeters to efficiently generate a full range of sound corresponding to two channels without requiring a plurality of discrete elements per channel.

Thus, the present invention enables the elimination of a discrete center channel speaker, and associated placement problems, and reduces the number of speaker elements required by multi channel speakers. Such a configuration reduces the cost and complexity of the speakers 10, 100, enables the utilization of fewer components, and reduces the size of the speaker enclosure 18 to improve aesthetics of the speaker system.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A speaker system operable to be coupled with a multi-channel sound system, the system comprising:
a first speaker including—
a first input operable to receive a left channel signal from the multi-channel sound system,
a second input operable to receive a center channel signal from the multi-channel sound system, and
a first dual voice coil speaker element coupled with the first and second inputs, the first dual voice coil speaker element operable to generate sound corresponding to the left channel signal and the center channel signal; and
a second speaker including—
a third input operable to receive a right channel signal from the multi-channel sound system,
a fourth input operable to receive the center channel signal from the multi-channel sound system, and
a second dual voice coil speaker element coupled with the third and fourth inputs, the second dual voice coil speaker element operable to generate sound corresponding to the right channel signal and the center channel signal.

2. The system of claim 1, wherein the first speaker and second speaker are operable to be positioned to generate stereo sound corresponding to the left and right channel signals and monaural sound corresponding to the center channel signal.

3. The system of claim 2, wherein the first speaker is operable to be positioned on a first side of a television and the second speaker is operable to be positioned on a second side of the television.

4. The system of claim 1, wherein the first speaker includes a first speaker enclosure for housing at least a portion of the first dual voice speaker element and the second speaker includes a second speaker enclosure for housing at least a portion of the second dual voice speaker element.

5. The system of claim 1, wherein the multi-channel sound system is a 5.1 channel sound system and the received signals correspond to 5.1-standard signals.

6. The system of claim 1, wherein—
the first speaker further includes a third dual voice coil speaker element coupled with the first and second inputs, the third dual voice coil speaker element comprising a woofer and the first dual coil speaker element comprising a tweeter, and
the second speaker further includes a fourth dual voice coil speaker element coupled with the third and fourth inputs, the fourth dual voice coil speaker element comprising a woofer and the second dual coil speaker element comprising a tweeter.

7. A speaker system operable to be coupled with a multi-channel sound system, the system comprising:
a first speaker including—
a first input operable to receive a left channel signal from the multi-channel sound system,
a second input operable to receive a center channel signal from the multi-channel sound system,
a first dual voice coil speaker element coupled with the first and second inputs, the first dual voice coil speaker element comprising a tweeter,
a second dual voice coil speaker element coupled with the first and second inputs, the second dual voice coil speaker element comprising a woofer, the first and second dual voice coil speaker elements being operable to generate sound corresponding to the left channel signal and the center channel signal, and
a first speaker enclosure for housing at least a portion of the first and second dual voice coil speaker elements; and
a second speaker including—
a third input operable to receive a right channel signal from the multi-channel sound system,
a fourth input operable to receive the center channel signal from the multi-channel sound system,
a third dual voice coil speaker element coupled with the third and fourth inputs, the first dual voice coil speaker element comprising a tweeter,
a fourth dual voice coil speaker element coupled with the third and fourth inputs, the fourth dual voice coil speaker element comprising a woofer, the third and fourth dual voice coil speaker elements being operable to generate sound corresponding to the right channel signal and the center channel signal, and
a second speaker enclosure for housing at least a portion of the third and fourth dual voice coil speaker elements, the first speaker and the second speaker being operable to be positioned to generate stereo sound corresponding to the left and right channel signals and monaural sound corresponding to the center channel signal.

8. The system of claim 7, wherein the first speaker enclosure is operable to be positioned on a first side of a television and the second speaker enclosure is operable to be positioned on a second side of the television to generate stereo and monaural sound.

9. The system of claim 7, wherein the multi-channel sound system is a 5.1 channel sound system and the received signals correspond to 5.1-standard signals.

10. A method of providing sound corresponding to a plurality of channel signals, the method comprising:
coupling a first dual voice coil speaker element with a left channel signal and a center channel signal;
coupling a second dual voice coil speaker element with a right channel signal and the center channel signal; and
positioning the first dual voice coil speaker element and the second dual voice coil speaker element to provide stereo sound corresponding to the left and right channel signals and monaural sound corresponding to the center channel signal.

11. The method of claim 10, wherein the first dual voice coil speaker element is positioned on a first side of a television and the second dual voice coil speaker element is positioned on a second side of the television.

12. The method of claim 10, wherein the speaker elements are coupled with a multi-channel sound system to receive the signals.

13. The method of claim 10, further including—
coupling a third dual voice coil speaker element with the left channel signal and the center channel signal, wherein the third dual voice coil speaker element comprises a woofer and the first dual voice coil speaker element comprises a tweeter,
coupling a fourth dual voice coil speaker element with the right channel signal and the center channel signal, wherein the fourth dual voice coil speaker element comprises a woofer and the second dual voice coil speaker element comprises a tweeter, and
positioning the third dual voice coil speaker element in proximity to the first dual voice coil speaker element and positioning the fourth dual voice coil speaker element in proximity to the second dual voice coil speaker element to provide stereo sound corresponding to the left and right channel signals and monaural sound corresponding to the center channel signal.

14. The method of claim 10, wherein the first dual voice coil speaker element is housed at least partially within a first speaker enclosure and the second dual voice coil speaker element is housed at least partially within a second speaker enclosure.
